(19) United States
(12) Patent Application Publication
(10) Pub. No.: US 2015/0226589 A1
(43) Pub. Date: Aug. 13, 2015

(54) X-Ray Based Multiphase Flow Meter with Energy Resolving Matrix Detector

(71) Applicant: SIEMENS AKTIENGESELLSCHAFT, Muenchen (DE)

(72) Inventors: Gennadiy Karpinskiy, Desnogorsk (RU); Stepan Polikhov, Ramenskoye (RU); Reiner Franz Schulz, Erlangen (DE)

(21) Appl. No.: 14/424,440

(22) PCT Filed: Apr. 24, 2013
(86) PCT No.: PCT/RU2013/000355

§ 371 Date: Feb. 26, 2015

(30) Foreign Application Priority Data
Aug. 27, 2012 (RU) PCT/RU2012/000700
Aug. 27, 2012 (RU) PCT/RU2012/000703

(51) Int. Cl. G01F 1/74; G01T 1/20; G01N 23/12

(52) U.S. Cl. CPC G01F 1/74; G01N 23/12; G01T 1/2018

(57) ABSTRACT

A method of X-ray based measurement of a multiphase flow components passing through a measurement tube comprises the steps of: directing a polychromatic photon beam generated by at least one X-ray source onto the measurement tube through which a multiphase flow is passed; locating a matrix detector behind the measurement tube along the beam, said matrix detector being a two-dimensional detecting structure comprising (mn) sensing elements and providing photon energy resolution, and exposing the measurement tube with multiphase flow by the X-ray pulses of a given duration and duty cycle; registering a polychromatic photon beam attenuated by said multiphase flow with an energy resolving matrix detector, whereas said matrix detector provides registration of a received photon beam according to different energy levels of the received photons and distribution of the received photons on energy levels according to spectral resolution of said matrix detector. A number of the energy levels registered by the matrix detector is defined as the ratio of maximum energy of the received photons to the spectral resolution of the array detector. A number of energy levels of interest is defined according to the number of components of said multiphase flow. For each X-ray pulse forming with the use of said matrix detector and in accordance with the defined number of energy levels a sequence of images of said multiphase flow, said images are characterized by pixel brightness; and determining from said formed sequence of images a volume content of each component of the multiphase flow basing on the value of the pixel brightness and in accordance with the law of absorption of X-ray emission. Then determining the flow rate of each component of the multiphase flow in the measuring tube in accordance with the cross-correlation analysis of the images formed by the matrix detector, and determining the volume flow rate of each phase of the multiphase flow as a product of the flow rate and the volume content of the phase.

### FIELD OF THE INVENTION

The present invention relates to nonintrusive techniques which allow real-time measurements of multiphase mixture flow rate and composition, and more particularly the present invention relates to X-ray based flow meter with energy resolving matrix detector. The invention is concerned a real-time measurements of a mixture of liquid hydrocarbons, e.g. oil, water and gaseous hydrocarbons.

For the purpose of material decomposition measurements at different X-ray energies or energy ranges are required.

The claimed invention is not limited to the application in the field of oil and gas business (liquids and gases), but is applicable to all cases of non-destructive testing where an unknown stream of substance is to be analyzed in terms of its composition and velocities. Some other examples comprise: waste management—shredded trash on a conveyor belt and ore winning—processed ore in tubes (in a liquid) or on conveyor belts (in solid form).

### BACKGROUND OF THE INVENTION

Because almost all wells produce a mixture of oil, water, and gas, flow measurements of the individual components of the fluid mixture are essential in the efficient production of a reservoir.

In the oil industry, the traditional practice is to separate the effluent into its component phases and to perform measurements on the phases separated in this way. However that technique requires separators to be installed on site, which separators are bulky and expensive items of equipment, and when testing wells, it also requires additional pipes to be put into place.

Numerous proposals have been put forward for developing techniques that would make it possible to avoid using such separators. The availability of a reliable, cheap, compact, and accurate multiphase meter would satisfy an important and long-felt need in oilfield completion and production operations.

The demand for such a device is especially high in upstream oil and gas business. It is important to measure individual flow rates of multiphase flow components without the need to interrupt fluid flow or separate the phases during measurement.

Apparatuses for nonintrusive multiphase flow measurements based on gamma or X-ray radiation interaction with flow are widely used in the field of art.

Among such proposals, U.S. Pat. No. 6,265,571 B1 describes a flow section for measurements concerning oil well effluent, the section comprising a pipe in parallel with a pipe connected to the well head. The flow section includes elements of material having low attenuation for gamma rays fixed in recesses formed in the wall of the pipe on its inside, and protection members disposed in housings connecting said recesses respectively to the outside, said housings being suitable for receiving gamma ray attenuation measuring means after the protection members have been removed.

The section provides determining at least one characteristic of oil well effluent constituted by multiphase fluid which typically comprises three phases: two liquid phases, crude oil and water, plus a hydrocarbon gas phase. In particular, the characteristics in question are the proportions of the component phases, including the water content of the liquid phase, and the flow-rate values—the total flow rate and the flow rates of the various phases.

Prior-art devices attempt to utilize differences in the absorption of X-rays or Gamma-rays by the oil, water, and gas components of the multiphase mixture. As is well-known by persons skilled in the art, such prior-art devices have limited accuracy, particularly in the case of gas fractions above 90%, a common situation in real-world applications.

U.S. Pat. No. 6,097,786 discloses method and apparatus for characterizing a multiphase mixture by irradiating the mixture with X-rays, collecting the photons that emanate from the mixture in response to the irradiation, generating a signal responsive to the aggregate energy of the collected photons, and analyzing the signal to characterize the mixture. Preferably, the mixture is irradiated by repetitively pulsing an X-ray tube and the photons are collected using a multi-layer detector. The method and apparatus may be used to determine the flow rate, flow velocities, and/or composition of the multiphase mixture. In other embodiments, a plurality of X-ray sources and/or detectors may be used.

The closest technical solution is disclosed in US 2012/0114097 wherein disclosed are an apparatus and method for measuring flow rate of a multi-phase fluid mixture. The apparatus comprises a radiation means, a detection means, and an analysis means. The radiation means generates a beam of photons to irradiate the mixture spatially over a section of flow of the mixture. The detection means is spatially configured for receiving photons emanating from the section of flow of the mixture at different intervals of time to form an image of spatial distribution of the received photons for each the interval of time. The analysis means is adapted for determining flow velocity of one or more phases of the mixture based on a temporal sequence of the images of the spatial distributions of the received photons.

In the mentioned document it is proposed to use simple photon counting matrix detector without a possibility to resolve photons' energy. It is well known that for three phase flow composition measurement X-ray photons at two different energies are required. In case of non-energy resolving detector (the so called integration detector) use the only possibility to measure three (or more) phase flow composition is to obtain two (o more) multiphase flow images at different moments of time (each time corresponds to X-ray impulse with predefined tube voltage). During time between the beginning of the first X-ray pulse and the end of the second X-ray pulse the multiphase flow in a pipe can move upstream sufficiently. This shift of multiphase flow during two exposures increases the uncertainty of measurements.

In all the above documents the absorption coefficient for X-rays strongly depends on the material and photon energy.

Using this fact one can use an X-ray source with two ranges of photon energies by applying two different high voltages. The photons which have a first or a “high” energy level have an absorption coefficient same for both oil and water. The photons which have a second or a low energy level are absorbed significantly stronger by water then by oil. The signals taken with two or more different high voltages of the X-ray tube can be used for material decomposition.

In another approach the X-rays pass through the pipe and irradiate two detectors. The first one is sensitive to the photons with lower energies. The second detector is placed behind the first one and is sensitive to the photons with higher energies. The first detector acts as a filter for the second one. Analysis of the signals recorded by these detectors allows evaluation of water, oil and gas concentrations in the multiphase mixture passing through the test section.

In U.S. Pat. No. 6,097,786 A, radioactive materials are offered as a source of dual energy X-ray, i.e. gamma-ray sources are used. In U.S. Pat. No. 6,265,713 B1 installation of two X-ray tubes is proposed. In WO 2011/005133 A1 one or several X-ray tubes and a two-dimensional array of detector elements or a set of detector elements arranged over a two-dimensional area (matrix detector) are used for multiphase flow measurement. Said matrix detector receives photons attenuated by a multiphase flow. Receiving of high and low energy level photons takes place at different moments of time with certain interval.

All of the known devices and methods do not provide satisfactory accuracy when measuring a volume flow rate of a multiphase flow.

### SUMMARY OF THE INVENTION

It is an object of the claimed invention to improve the drawbacks of the known methods and to provide a method of X-ray based volume flow rate measurement of a multiphase flow passing through a measurement tube.

It is an object of the claimed invention to provide a X-ray based flow meter for measuring components of a multiphase flow which is directed to overcoming the disadvantages inherent in prior art devices.

According to the first aspect it is provided a method of X-ray based measurement of a multiphase flow components passing through a measurement tube, comprising the steps of:

directing a polychromatic photon beam generated by at least one X-ray source onto the measurement tube through which a multiphase flow is passed;

locating a matrix detector behind the measurement tube along the beam, said matrix detector being a two-dimensional detecting structure comprising (m×n) sensing elements and providing photon energy resolution, and exposing the measurement tube with multiphase flow by the X-ray pulses of a given duration and duty cycle;

registering a polychromatic photon beam attenuated by said multiphase flow with an energy resolving matrix detector, whereas said matrix detector provides registration of a received photon beam according to different energy levels of the received photons and distribution of the received photons on energy levels according to spectral resolution of said matrix detector;

whereas a number of the energy levels registered by the matrix detector is defined as the ratio of maximum energy of the received photons to the spectral resolution of the array detector;

defining a number of energy levels of interest according to the number of components of said multiphase flow;

forming for each X-ray pulse with the use of said matrix detector and in accordance with the defined number of energy levels a sequence of images of said multiphase flow, said images are characterized by pixel brightness;

determining from said formed sequence of images a volume content of each component of said multiphase flow basing on the value of the pixel brightness of the formed images and in accordance with the law of absorption of X-ray emission basing on the set of equations describing the absorption of emission by multiphase medium;

determining the flow rate of each component of the multiphase flow in the measuring tube in accordance with the cross-correlation analysis of the images formed by the matrix detector, and determining the volume flow rate of each phase of the multiphase flow as a product of the flow rate and the volume content of the phase.

Preferably, said matrix detector has a shape selected from a grope consisting of a flat rectangle and semi-cylinder (semi-tube).

According to the second aspect it is provided a method of X-ray based measurement of a multiphase flow components passing through a measurement tube, comprising the steps of:

simultaneously generating two polychromatic photon beams by a main and a secondary X-ray sources, the main source generating low energy X-rays, and the secondary source generating high energy X-rays, directing two polychromatic photon beams onto the measurement tube through which a multiphase flow is passed;

locating a matrix detector behind the measurement tube along the beam, said matrix detector being a two-dimensional detecting structure comprising (m×n) sensing elements and providing photon energy resolution, and exposing the measurement tube with multiphase flow by the X-ray pulses of a given duration and duty cycle;

registering two polychromatic photon beams attenuated by said multiphase flow with an energy resolving matrix detector, whereas said matrix detector provides registration of a received photon beams according to different energy levels of the received photons and distribution of the received photons on energy levels according to spectral resolution of said matrix detector;

whereas a number of the energy levels registered by the matrix detector is defined as the ratio of maximum energy of the received photons to the spectral resolution of the array detector;

defining a number of energy levels of interest according to the number of components of said multiphase flow;

forming for each X-ray pulse with the use of said matrix detector and in accordance with the defined number of energy levels a sequence of images of said multiphase flow, said images are characterized by pixel brightness;

determining from said formed sequence of images a volume content of each component of said multiphase flow basing on the value of the pixel brightness of the formed images and in accordance with the law of absorption of X-ray emission basing on the set of equations describing the absorption of emission by multiphase medium;

determining the flow rate of each component of the multiphase flow in the measuring tube in accordance with the cross-correlation analysis of the images formed by the matrix detector, and determining the volume flow rate of each phase of the multiphase flow as a product of the flow rate and the volume content of the phase.

Preferably said matrix detector has a shape selected from a grope consisting of a flat rectangle and semi-cylinder (semi-tube).

According to the third aspect it is provided an X-ray based multiphase flow meter for measuring components of a multiphase flow passing through a measurement tube, comprising:

at least one X-ray source generating a polychromatic photon beam;

a measurement tube to pass the multiphase flow;

a matrix detector located behind the measurement tube along the beam, said matrix detector being a two-dimensional detecting structure comprising (m×n) sensing elements, whereas said matrix detector provides registration of a received photon beam according to different energy levels of the received photons and distribution of the received photons on energy levels according to spectral resolution of said matrix detector, and

whereas a number of the energy levels registered by the matrix detector is defined as the ratio of maximum energy of the received photons to the spectral resolution of the array detector;

an image forming unit configured for forming a number of images of said multiphase flow for each X-ray pulse with the use of said matrix detector and in accordance with the defined number of energy levels, said images are characterized by pixel brightness;

a visualization unit connected to the image forming unit;

a volume determining unit configured for determining from said formed of a sequence of images a volume content of each component of said multiphase flow basing on the value of the pixel brightness of the formed images and in accordance with the law of absorption of X-ray emission basing on the set of equations describing the absorption of emission by multiphase medium;

a speed determination unit configured for determining the rate of each component of the multiphase flow in the measuring tube in accordance with the cross-correlation analysis of the images formed by the matrix detector, and determining the volume flow rate of each phase of the multiphase flow as a product of the flow rate and the volume content of the phase.

The present invention ensures the attainment of the following technical effects:
Owing to the use of a matrix detector, which is a two-dimensional detecting structure and which provides photon energy resolution, accuracy of measurements can be improved;
Only one exposure is required to determine the content of a multiphase flow consisting of more than two components;
No switching of the anode voltage is required.

During a single exposure (one pulse) the present device generates two or more images by registering a beam of emitted X-ray photons, which is attenuated after passing through a multiphase flow tube, taking into account energy of individual photons. Then, on basis of two or more images registered from different energy photons and at the same time the volume flow rate of each component of the multiphase flow can be calculated with high accuracy. Since several photon energies are distributed by a matrix detector, individual phase velocities of the multiphase flow can be determined without the use of complex algorithms, thereby decreasing demands for computational means.

The present method and apparatus improve the quality of material decomposition and enhance the accuracy of measurements. The robustness of the present apparatus is superior than that of the prior art apparatus owing to the fact that the number of required exposures is reduced and no fast switching of the anode voltage and X-ray tube current is required.

### BRIEF DESCRIPTION OF THE DRAWINGS

The invention will be further illustrated by the description of its embodiments with reference to the accompanying drawings, wherein:

FIG. 1 is a schematic view of an X-ray based flow meter for measurement of multiphase flow components, comprising a single X-ray tube, according to a first embodiment of the invention;

FIG. 2 is a top view of an X-ray based flow meter for measurement of multiphase flow components according to the invention;

FIG. 3 is a general view of a matrix detector according to the invention;

FIG. 4 shows an example of quantity of photons emitted by X-ray tube in dependency of photon energy, according to the invention;

FIG. 5 shows a scheme of a system comprising an X-ray based flow meter for measurement of multiphase flow components, a detection unit, an image forming unit and a computer with software for velocity and composition calculations, according to the invention;

FIG. 6a, 6b, show embodiments of a matrix detector, which has the shape of a flat rectangle and semi-cylinder (semi-tube), according to the invention;

FIG. 7 shows a schematic view of an X-ray based flow meter for measurement of multiphase flow components, comprising two X-ray tubes according to a second embodiment of the invention.

### DETAILED DESCRIPTION OF THE PREFERRED EMBODIMENTS

Wherever possible, the same reference numerals used throughout the drawings refer to the same or like parts.

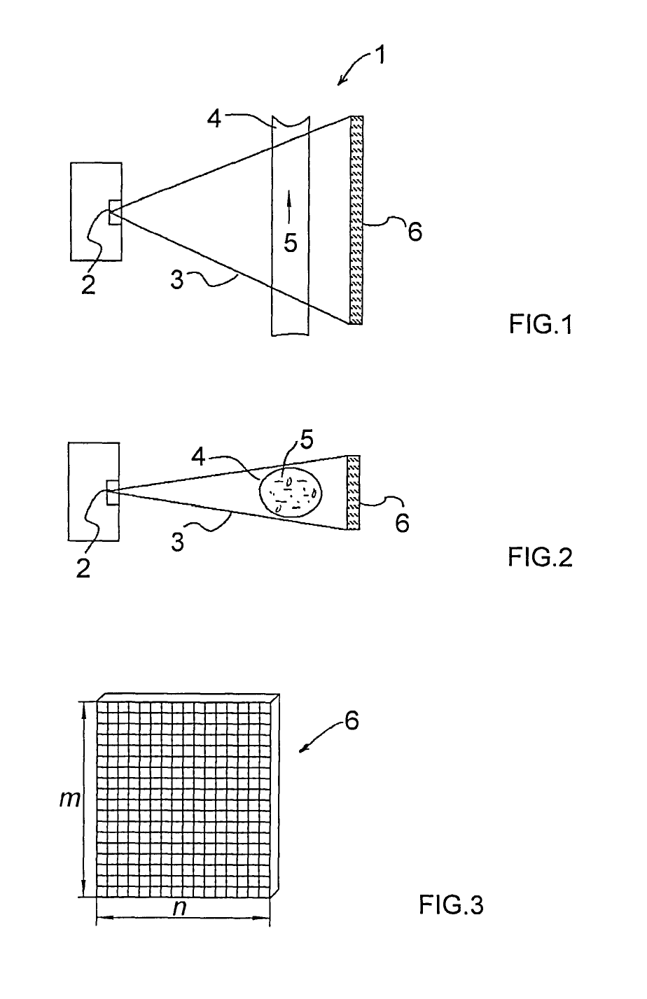

An X-ray based flow meter 1 (FIG. 1) for measurement of components of a multiphase flow passing through a measurement tube comprises at least one X-ray source 2, which generates a polychromatic photon beam 3. The embodiment shown in FIG. 1 comprises one X-ray source 2.

The X-ray based flow meter 1 further comprises a measurement tube 4 to pass a multiphase flow 5. FIG. 2 shows a top view, where the formed photons beam 3 completely envelopes the measurement tube 4.

A matrix detector 6, located behind the measurement tube 4 along the beam, is a two-dimensional detecting structure comprising (m×n) sensing elements (FIG. 3)(for example, pin-diode, Schottky diode on base of CeZnTe, etc.) and providing registration of a received photon beam according to different energy levels of the received photons and distribution of the received photons on specified energy levels according to spectral resolution of the matrix detector.

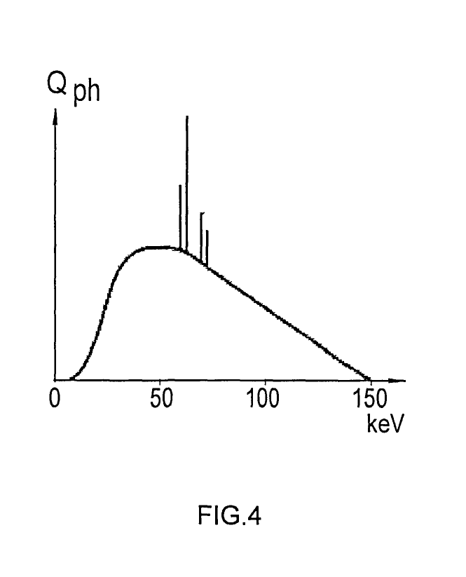

FIG. 4 shows distribution of photon energy of the X-ray tube.

Number of energy levels registered by the matrix detector 6 is defined as the ratio of maximum energy of the received photons to the spectral resolution of the matrix detector. For example, if maximum energy of photons received during a single exposure is 80 keV, and spectral resolution of a matrix detector is 10 keV, the number of energy levels is 8.

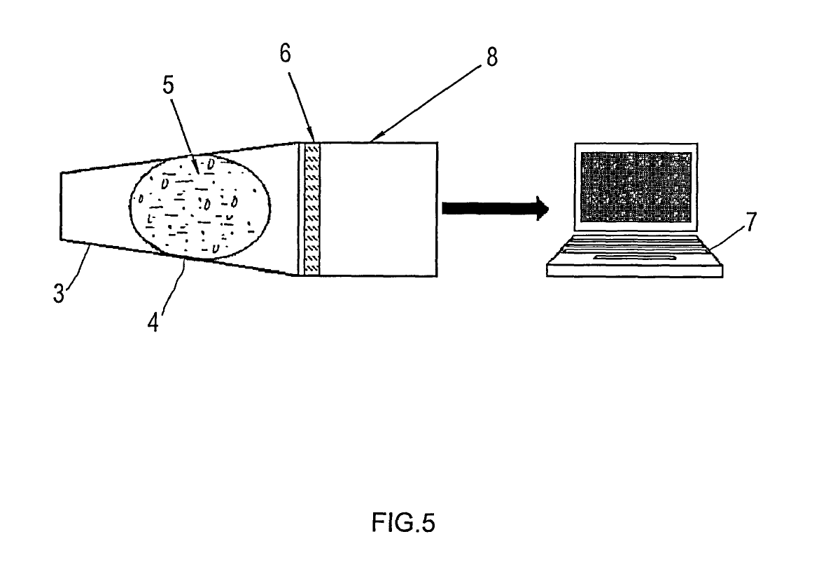

An X-ray based flow meter 1 (FIG. 5) comprises a unit for determining a specified number of energy levels of interest in accordance with the number of components of the multiphase flow 5 passing through the measurement tube 4. In the described embodiment, the unit is a software component executed by a computer 7 (FIG. 5).

The X-ray based flow meter 1 (FIG. 5) further comprises an image forming unit 8, which is a software component configured to generate a sequence of images of multiphase flow for each X-ray pulse according to the defined number of energy levels, each image being characterized by pixel brightness.

Detector's pixel receives a photon, determines its energy and puts it in a bin. Brightness of image pixel is equal to the number of photons in respective bin.

The X-ray based flow meter 1 (FIG. 5) comprises a volume determining unit configured to determine a volume content of each component of the multiphase flow from the sequence of images basing on the pixel brightness values of the formed images and in accordance with the law of absorption of X-ray emission basing on the set of equations describing the absorption of X-ray emission by multiphase medium. In the described embodiment, the unit is a software component executed by the computer 7.

The X-ray based flow meter 1 (FIG. 5) also comprises a unit for determining velocity of each component of the multiphase medium in the measurement tube in accordance with the cross-correlation analysis of the images formed by the matrix detector under the effect of received photons, for subsequent determination of volume flow rate of each phase of the multiphase medium as the product of the flow rate and the volume content of the phase. In the described embodiment, the unit is also a software component executed by the computer 7.

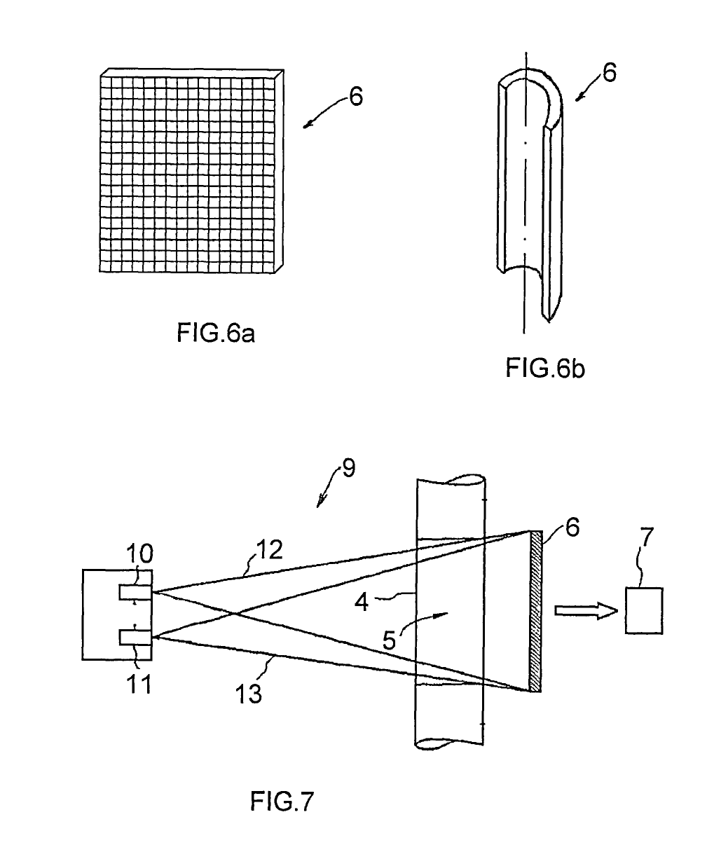

The matrix detector 6 used in the X-ray based flow meter 1 has a shape selected from the group consisting of a flat rectangle (FIG. 6a) and a semi-cylinder (semi-tube) (FIG. 6b).

In yet another embodiment of the invention the X-ray based flow meter 9 (FIG. 7) for measurement of components of a multiphase flow passing through a measurement tube comprises two X-ray sources 10, 11, which generate two polychromatic photon beams 12, 13.

Operation of the X-ray based flow meter according to the first and second embodiment is explained below.

A method of X-ray based measurement of multiphase flow components passing through a measurement tube comprises the following steps.

A polychromatic photons beam generated by one X-ray source 2 (FIG. 1) is directed onto a measurement tube 4 through which a multiphase flow 5 is passed.

A matrix detector 6, which is a two-dimensional detecting structure comprising (m×n) sensing elements and which provides photon energy resolution, is located behind the measurement tube 4 along the photon beam, and the measurement tube 4 with the multiphase flow 5 is exposed to X-ray pulses of given duration and duty cycle.

The polychromatic photon beam 3, which has passed through the measurement tube, is received at the matrix detector 6. The matrix detector 6 registers the received photon beam according to different energy levels of the received photons and distributes the received photons on energy levels according to spectral resolution of the matrix detector 6.

Number of the energy levels registered by the matrix detector is defined as the ratio of maximum energy of the received photons to the spectral resolution of the matrix detector 6. Distribution of photon energy is shown in FIG. 4.

The number of energy levels of interest is defined in accordance with the number of components of the multiphase flow.

The matrix detector 6 counts photons of different energy levels as photons of the same energy level, so the matrix detector provides summation of photons. The flow of photons is attenuated by water, which is a component of the flow, less attenuated by oil, and almost not attenuated by gas.

The matrix detector constructs image based on brightness.

If a multiphase flow comprises two phases, such as oil and water, one shot is enough. If the multiphase medium flow has three phases, such as oil, gas, and water, it is necessary to make two shots. Shots are taken either by a single source, which takes two shots in a row, that is, at different times, to get the third equation for the third component, or two photon sources are required to take shots simultaneously.

The process is described by the following equations:

I=Iₒe^{(-α1}*^{l1-α2 l2-α3}*^{l3)}

l1+l2+l3=d

where: I is the signal on the detector (in this case, pixel brightness); Iₒ is the coefficient defined by calibration; α1—the absorption coefficient of the first phase; α2—the absorption coefficient of the second phase, α3—the absorption coefficient of the third phase, l2—the thickness of the second phase; l1—the thickness of the first phase and so on.

To have two sources is quite expensive and halves the reliability of the device, and projections are different, so the accuracy is impaired. On the other hand, if a single source is used, switching takes time, during which the flow can significantly shift along the measurement tube, thereby impairing the accuracy.

The used matrix detector counts each photon, i.e. the matrix detector determines energy of the received photon and classifies the photons on energies, although not in absolute terms, but in a range that is set in advance on the basis of data obtained experimentally.

For example, for three-component multiphase flow two ranges are chosen:

20-30 keV;

60-70 keV.

X-ray beam is not a monochromatic beam. One X-ray pulse forms a plurality of photons, which have different energies (as shown below).

Matrix detector generates as much images as there are ranges (energy-bins). Matrix detector was never used in the oil and gas industry for the formation of pictures of a multiphase flow to measure volume flow rates of its components.

Volume content of each multiphase flow component is determined from the formed sequence of images basing on pixel brightness values of the formed images and in accordance with the law of absorption of X-ray emission basing on the set of equations describing the absorption of emission by multiphase medium.

Velocity of each multiphase flow component in the measurement tube is determined in accordance with the cross-correlation analysis of the images formed by the matrix detector, and volume flow rate of each phase of the multiphase medium is determined as the product of the flow rate and the volume content of the phase.

In case of two X-ray sources (FIG. 7), the method of X-ray based measurement of multiphase flow components passing through a measurement tube comprises the following steps.

Two polychromatic photons beams 12 and 13 are simultaneously generated by a main and secondary X-ray sources 10 and 11, where the main source 10 has a low (e.g. 30 kV) anode voltage, and the secondary source 11 has a high (e.g. 80 kV) anode voltage of the X-ray tube; the polychromatic photons beams 12 and 13 are directed onto the measurement tube 4 through which a multiphase flow 5 is passed.

A matrix detector 6, which is a two-dimensional structure consisting of (m×n) sensors and which provides photon energy resolution, is located behind the measurement tube 4 along the beam, and the measurement tube with the multiphase flow is exposed to X-ray pulses of given duration and duty cycle.

Two polychromatic photon beams passed through the measurement tube are received on the matrix detector 6, which provides registration of received photon beams according to different energy levels of the received photons and distribution of the received photons on energy levels according to its spectral resolution.

Number of energy levels registered by the matrix detector is defined as the ratio of maximum energy of received photons to the spectral resolution of the matrix detector.

Number of energy levels of interest is defined in accordance with the number of components of the multiphase flow.

A sequence of images of the multiphase flow is formed for each X-ray pulse using the matrix detector and in accordance with the defined number of energy levels, the images being characterized by pixel brightness.

Having regard to the range of X-ray tube, it can be seen that there is a lot of photons of one energy, and a few photons of other energy, that is different intensities at different energies. If two X-ray tubes are used, they should be set so that the beam of photons passing through the measuring tube 4 had a lot of low-energy and high-energy photons. This can greatly improve the image quality and signal/noise ratio.

Volume content of each component of the multiphase flow is determined from the formed sequence of images basing on the pixel brightness values and in accordance with the law of absorption of X-ray emission basing on the set of equations describing the absorption of emission by multiphase medium.

Velocity of each component of the multiphase flow in the measurement tube is determined in accordance with the cross-correlation analysis of the images formed by the matrix detector, and volume flow rate of each phase of the multiphase medium is determined as the product of the flow rate and the volume content of the phase.

We claim:

1. A method of X-ray based measurement of a multiphase flow components passing through a measurement tube, comprising the steps of:
directing a polychromatic photon beam generated by at least one X-ray source onto the measurement tube through which a multiphase flow is passed;
locating a matrix detector behind the measurement tube along the beam, said matrix detector being a two-dimensional detecting structure comprising (m×n) sensing elements and providing photon energy resolution, and exposing the measurement tube with multiphase flow by the X-ray pulses of a given duration and duty cycle;
registering a polychromatic photon beam attenuated by said multiphase flow with an energy resolving matrix detector, whereas said matrix detector provides registration of a received photon beam according to different energy levels of the received photons and distribution of the received photons on energy levels according to spectral resolution of said matrix detector;
whereas a number of the energy levels registered by the matrix detector is defined as the ratio of maximum energy of the received photons to the spectral resolution of the array detector;
defining a number of energy levels of interest according to the number of components of said multiphase flow;
forming for each X-ray pulse with the use of said matrix detector and in accordance with the defined number of energy levels a sequence of images of said multiphase flow, said images are characterized by pixel brightness;
determining from said formed sequence of images a volume content of each component of said multiphase flow basing on the value of the pixel brightness of the formed images and in accordance with the law of absorption of X-ray emission basing on the set of equations describing the absorption of emission by multiphase medium;
determining the flow rate of each component of the multiphase flow in the measuring tube in accordance with the cross-correlation analysis of the images formed by the matrix detector, and determining the volume flow rate of each phase of the multiphase flow as a product of the flow rate and the volume content of the phase.

2. A method of X-ray based volume flow rate measurement of a multiphase flow components of claim 1, wherein said matrix detector has a shape selected from a grope consisting of a flat rectangle and semi-cylinder.

3. A method of X-ray based measurement of a multiphase flow components passing through a measurement tube, comprising the steps of:
simultaneously generating two polychromatic photon beams by a main and a secondary X-ray sources, the main source generating low energy X-rays, and the secondary source generating high energy X-rays, directing two polychromatic photon beams onto the measurement tube through which a multiphase flow is passed;
locating a matrix detector behind the measurement tube along the beam, said matrix detector being a two-dimensional detecting structure comprising (m×n) sensing elements and providing photon energy resolution, and exposing the measurement tube with multiphase flow by the X-ray pulses of a given duration and duty cycle;
registering two polychromatic photon beams attenuated by said multiphase flow with an energy resolving matrix detector, whereas said matrix detector provides registration of a received photon beams according to different energy levels of the received photons and distribution of the received photons on energy levels according to spectral resolution of said matrix detector;
whereas a number of the energy levels registered by the matrix detector is defined as the ratio of maximum energy of the received photons to the spectral resolution of the array detector;
defining a number of energy levels of interest according to the number of components of said multiphase flow;
forming for each X-ray pulse with the use of said matrix detector and in accordance with the defined number of energy levels a sequence of images of said multiphase flow, said images are characterized by pixel brightness;
determining from said formed sequence of images a volume content of each component of said multiphase flow basing on the value of the pixel brightness of the formed images and in accordance with the law of absorption of X-ray emission basing on the set of equations describing the absorption of emission by multiphase medium;
determining the flow rate of each component of the multiphase flow in the measuring tube in accordance with the cross-correlation analysis of the images formed by the matrix detector, and determining the volume flow rate of each phase of the multiphase flow as a product of the flow rate and the volume content of the phase.

4. A method of X-ray based measurement of a multiphase flow components of claim 3, wherein said matrix detector has a shape selected from a grope consisting of a flat rectangle and semi-cylinder.

5. An X-ray based multiphase flow meter for measuring components of a multiphase flow passing through a measurement tube, comprising:
at least one X-ray source generating a polychromatic photon beam;
a measurement tube to pass the multiphase flow;
a matrix detector located behind the measurement tube along the beam, said matrix detector being a two-dimensional detecting structure comprising (m×n) sensing elements, whereas said matrix detector provides registration of a received photon beam according to different energy levels of the received photons and distribution of the received photons on energy levels according to spectral resolution of said matrix detector, and
whereas a number of the energy levels registered by the matrix detector is defined as the ratio of maximum energy of the received photons to the spectral resolution of the array detector;
an image forming unit configured for forming a number of images of said multiphase flow for each X-ray pulse with the use of said matrix detector and in accordance with the defined number of energy levels, said images are characterized by pixel brightness;
a visualization unit connected to the image forming unit;
a volume determining unit configured for determining from said formed of a sequence of images a volume content of each component of said multiphase flow basing on the value of the pixel brightness of the formed images and in accordance with the law of absorption of X-ray emission basing on the set of equations describing the absorption of emission by multiphase medium;
a speed determination unit configured for determining the rate of each component of the multiphase flow in the measuring tube in accordance with the cross-correlation analysis of the images formed by the matrix detector, and determining the volume flow rate of each phase of the multiphase flow as a product of the flow rate and the volume content of the phase.
